(19) United States
(12) Patent Application Publication
(10) Pub. No.: US 2026/0168298 A1
(43) Pub. Date: Jun. 18, 2026

(54) STORAGE BOX MOUNTING PLATE WITH LOCKING MECHANISM

(71) Applicant: Essentially Engineered, LLC, Cheyenne, WY (US)

(72) Inventor: Jacob LOVASZ, Westminster, CO (US)

(73) Assignee: Essentially Engineered, LLC, Cheyenne, WY (US)

(21) Appl. No.: 19/529,596

(22) Filed: Feb. 4, 2026

Related U.S. Application Data
(63) Continuation of application No. 18/677,249, filed on May 29, 2024.

(51) Int. Cl. E05C 19/00; E05B 27/00

(52) U.S. Cl. CPC E05C 19/003; E05B 27/0042

(57) ABSTRACT

A mounting plate for a storage box, has a rigid plate having a front face having a surface, a back face opposite the front face, and at least one passage through the front face to the back face to receive a portion of a storage box. The mounting plate has a lock with a key mechanism accessible from a user side. The lock has a rotatable locking bar positioned on the second side, the rotatable locking bar having a flange, the rotatable locking bar further responsive to an activation of the key mechanism, whereby the flange is configured to engage the storage box when the lock is in a locked configuration. The passage and the rotatable locking bar affix the storage box substantially adjacent the front face of the rigid plate when the lock is in the locked configuration.

### TECHNICAL FIELD

Embodiments herein are related to means for safely supporting a storage box relative to a truck bed surface.

### BACKGROUND

It is very common for tradespersons to carry many tools along with them, such as in the bed of a truck, to job sites. These tools require numerous attachments, such as drill bits, or nails, that require careful organization. The market today currently has many storage boxes, such as the Milwaukee Packout (the Milwaukee brand is not associated with the Applicant), that may be nested onto mounting plates, which are typically permanently affixed to the side or bottom of a truck bed.

However, the Milwaukee Packout system provides no means to prevent others from stealing the storage boxes from the bed of a pickup truck. Theft is therefore a common problem when transporting tools or other goods in the bed of a pickup truck.

Those who wish to prevent theft, of course, may use a van instead of a truck, attach a top to the bed of the truck, or turn to expensive locking toolboxes that cost in the thousands of dollars. However, these solutions are both cost prohibitive and not useful for many.

Specifically, the currently available solutions to prevent theft, like vans, truck tops, and locking toolboxes occupy up a lot of room, thereby reducing the space available to transport the necessary tools and pushing the tradespersons into using ever larger vehicles and the associated cost and environmental damage.

There thus remains a need for an improved mounting plate that does not reduce the transport space available to the user, and/or other new and innovative solutions.

### SUMMARY

A mounting plate for a storage box has a rigid plate and a lock. The rigid plate has a front face having a surface, a back face opposite the front face, and at least one passage through the front face to the back face, the passage shaped and configured to receive a portion of a storage box. The lock is for temporarily locking the storage box to the rigid plate. The lock has a key mechanism accessible from a user side, the user side positioned on a side not being the second side. The lock has a rotatable locking bar positioned on the second side, the rotatable locking bar having a flange, the rotatable locking bar further responsive to an activation of the key mechanism, whereby the flange is configured to engage the storage box when the lock is in a locked configuration. The passage and the rotatable locking bar are shaped and configured to affix the storage box substantially adjacent the front face of the rigid plate when the lock is in the locked configuration.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background

### BRIEF DESCRIPTION OF THE DRAWINGS

FIG. 1 is a perspective view of a first embodiment of the mounting plate;

FIG. 2 is a front view thereof;

FIG. 3 is a back view thereof;

FIG. 4 is a right side view thereof;

FIG. 5 is a left side view thereof;

FIG. 6 is a top view thereof;

FIG. 7 is a bottom view thereof;

FIG. 8 is a detailed view of a lock suitable for use in the first embodiment of the mounting plate;

FIG. 9 is a perspective view of a second embodiment of the mounting plate;

FIG. 10 is a front view thereof;

FIG. 11 is a back view thereof;

FIG. 12 is a right side view thereof;

FIG. 13 is a left side view thereof;

FIG. 14 is a top view thereof;

FIG. 15 is a bottom view thereof; and

FIG. 16 is a detailed view of a lock suitable for use in the second embodiment of the mounting plate.

### DETAILED DESCRIPTION

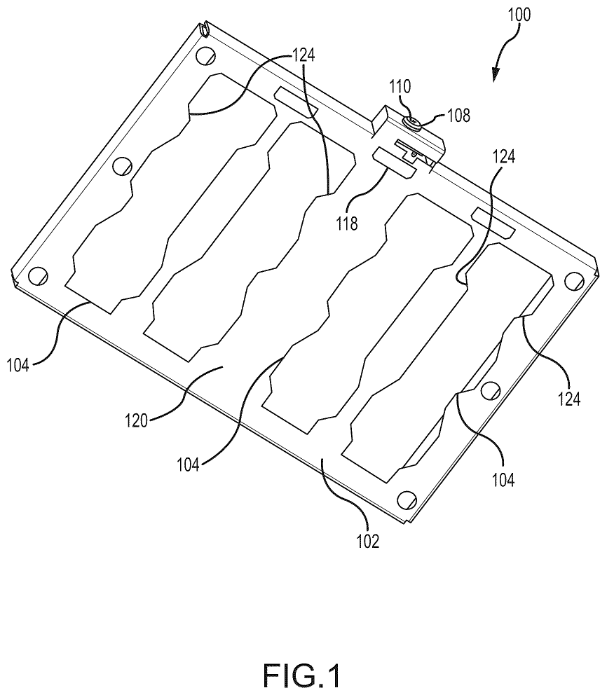

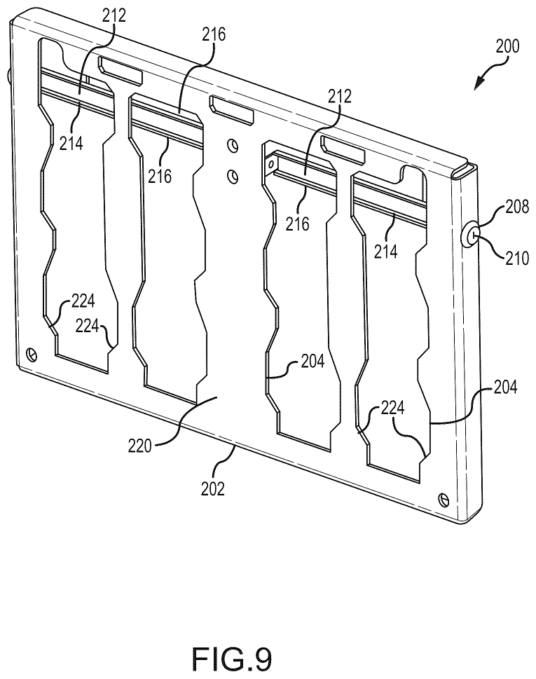

With reference now to FIGS. 1, 3, 9 and 11, a mounting plate 100, 200 for a storage box is now described in detail. FIG. 1 illustrates a first embodiment of the mounting plate 100, and FIG. 9 illustrates a second embodiment of the mounting plate 200. The two embodiments function in substantially similar manners. As will be described in more detail below, both embodiments of the mounting plate 100, 200 have a rigid plate, 102, 202, a means 106, 206 for mounting the mounting plate 100, 200 to a surface (not shown), and a lock 108, 208.

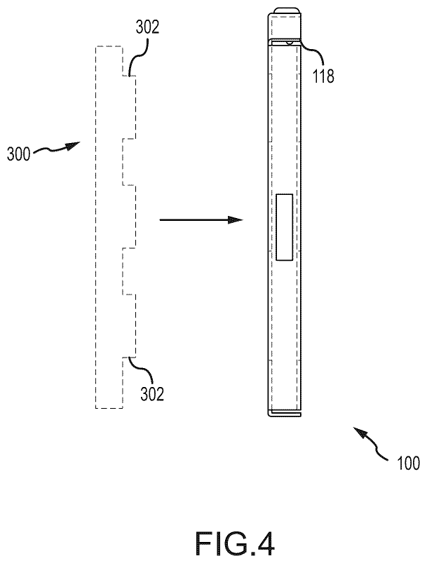

More specifically, the mounting plate 100, 200 has a rigid plate 102, 202 having at least one recess 104, 204 for receiving a portion of a storage box. The invention does not include the storage box itself; however, to understand how a storage box might engage the mounting plate 100, 200, brief reference is made to FIG. 4, which illustrates a (disclaimed) storage box 300 approaching engagement with the mounting plate 100, 200. That is, the (at least one) recess 104, 204 may be configured to receive one or more protrusions 302 in the storage box 300.

As seen, the recess 104, 204 may be a passage through a front face 120, 220 and a back face 122, 222 of the rigid plate 102, 202, and may be shaped and configured to receive a protrusion on the storage box 300 (see FIG. 4), such that a portion of the storage box 300 abuts the front face 120, 220 of the rigid plate 102, 202.

The recess 104, 204 may have one or more ledges 124, 224 shaped and configured to engage a lower portion of the protrusion 302 on the storage box 300. Those of skill in the art will recognize that, when engaged, the storage box 300 will rest on the ledge(s) 124, 224 when the mounting plate 100, 200 is in the vertical position; thus, when the lock 108, 208 is engaged, the storage box 300 cannot be easily removed, such as by theft. More specifically, the ledge(s) 124, 224 may prevent the storage box 300 from moving vertically, while the lock 108, 208, when engaged with a flange (not shown) in the storage box 300 may prevent the storage box 300 from moving horizontally relative to the mounting plate 100, 200; alternatively stated, the lock 108, 208 may be shaped and configured to prevent the storage box 300 from moving away from the mounting plate 100, 200 when in a locked configuration or when engaged with a flange (not shown) in the storage box 300 in a manner known to those of skill in the art.

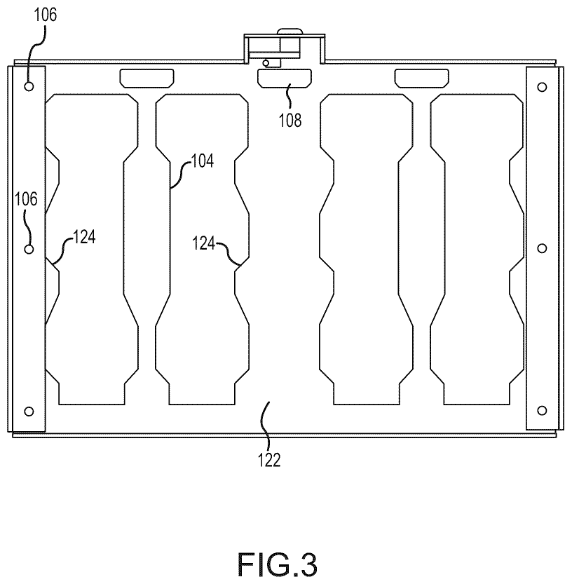

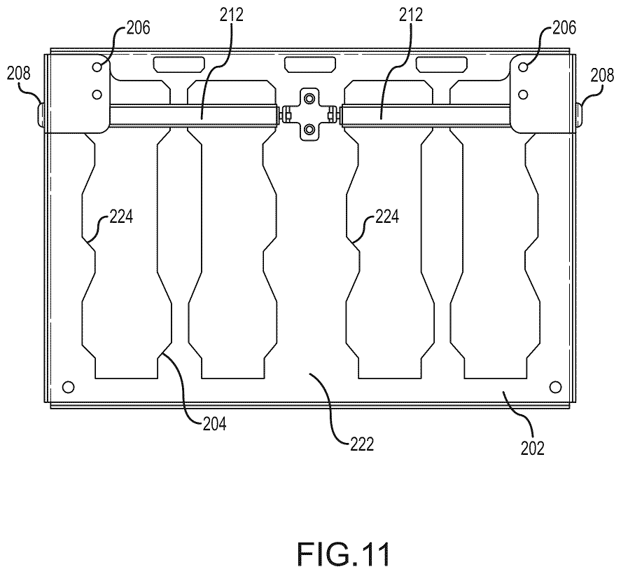

The means for mounting the mounting plate 100, 200 to a surface 106, 206, seen most clearly in FIG. 3 and FIG. 11, may include a plurality of mounting holes. The mounting holes may be shaped and configured to receive screws (not shown) to attach the mounting plate 100, 200 to the surface (not shown). The means for mounting the mounting plate may include hooks, flanges, nails, screws, glue, hook-and-loop fasteners, or any other fastener suitable for holding a rigid plate to a vertical or flat surface. That is, the holes as shown are not the only means 106, 206 for attaching the mounting plate 100, 200 to a surface.

The mounting plate 100, 200 also includes a lock 108, 208 for temporarily locking the storage box 300 to the rigid plate 104, 204. The lock 108, 208 may have a key mechanism 110, 210 accessible from a user side in a manner known to those of skill in the art. The key mechanism 110, 210 may include a lock cylinder, not shown in detail in the figures, as known to those skilled in the art.

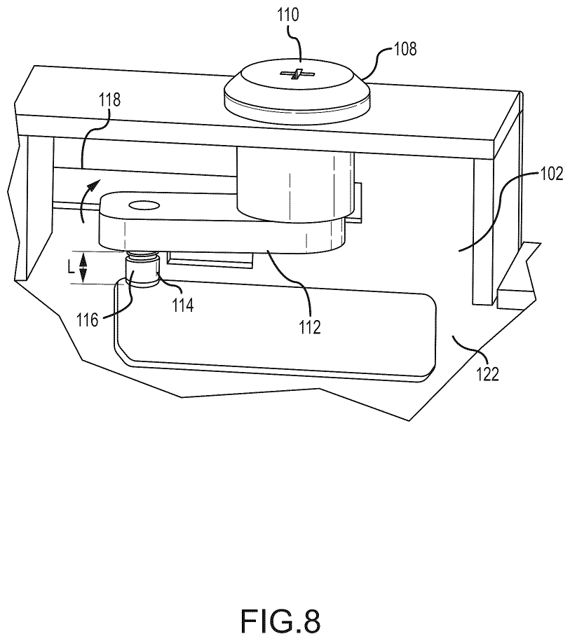

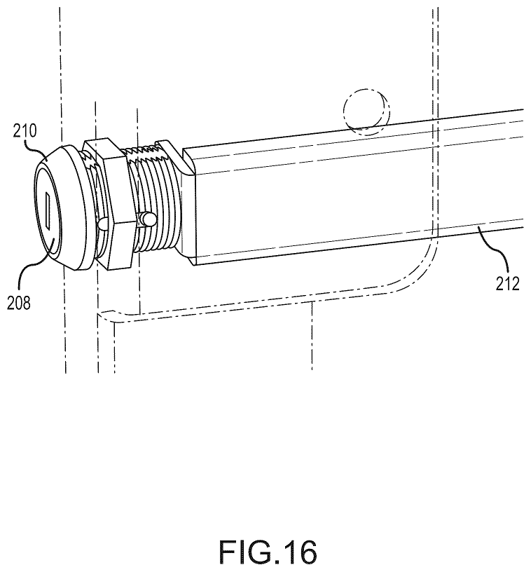

As best shown in FIG. 8 and FIG. 16, the lock 108, 208 may have a rotatable locking bar 112, 212 responsive to an activation of the key mechanism 110, 210, and an arm 114, 214 (see FIG. 9 for a clear view of the locking bar 212 and arm 214 of the second embodiment) for engaging the storage box 300 when the lock 108, 208 is in a locked configuration. The arm 114, 214 may function substantially as a flange surface to engage a corresponding flange surface (not shown) in the storage box 300.

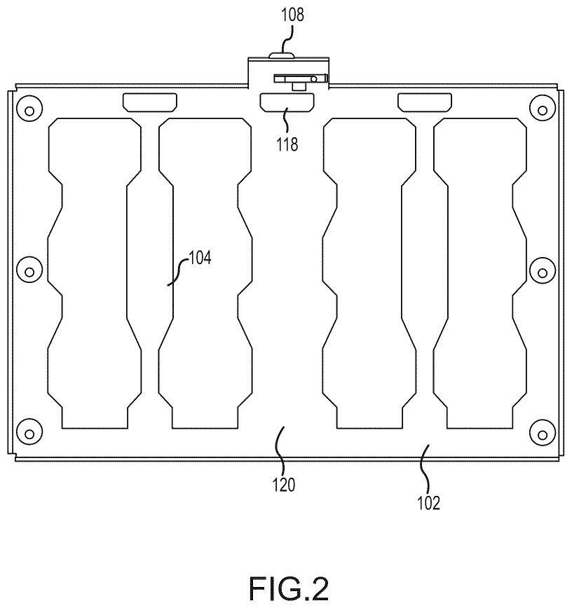

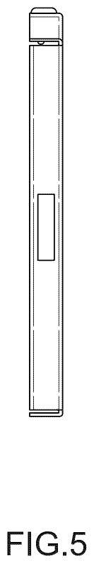

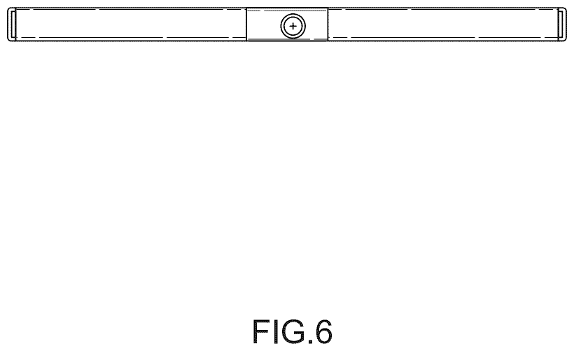

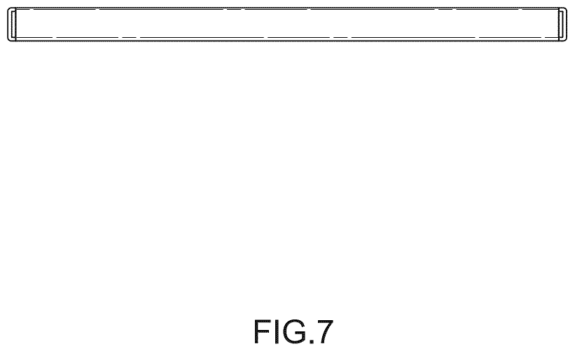

In some embodiments, such as the embodiment illustrated in FIGS. 1-8, the arm 114 includes or is an elongated pin 116. The pin 116 may have a threaded engagement with the rotatable locking bar 112, whereby an extension length L of the elongated pin 116 is adjustable relative to the locking bar 112. This adjustable feature allows for the mounting plate 100 to receive certain storage boxes 300 having different sizes with flanges in various locations.

Continuing now with FIGS. 1-8, the locking feature of a first embodiment is described in more detail. After propping the storage box 300 into the recess(es) 104 of the mounting plate 100, a user may operate the lock 108 to rotate the locking bar 112 to cause a distal portion of the locking bar 112 and the pin 116 to pass through a passage 118 in the rigid plate 102 to engage a flange surface (not shown) in the storage box 300, thereby preventing the storage box 300 from being removed, so long as the lock 108 is in the locked configuration. That is, in the locked configuration, the lock 108, 208 prevents the storage box 300 from moving away from a face 120, 220 of the rigid plate 102, 202, while the ledge(s) 124, 224 prevents the storage box 300 from moving vertically.

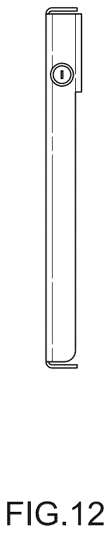

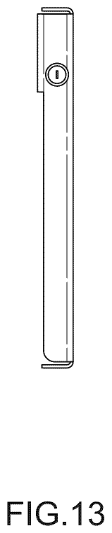

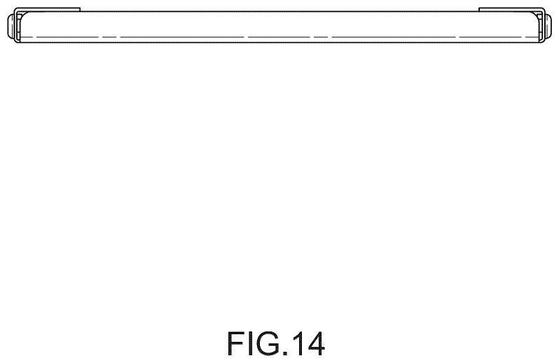

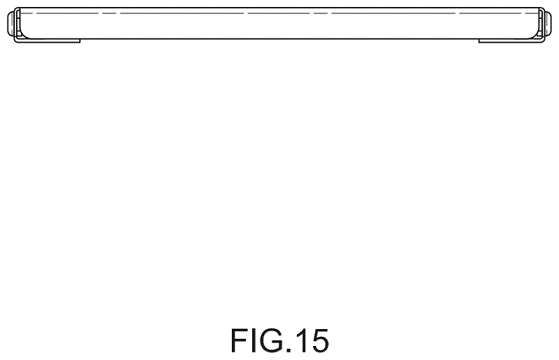

In some embodiments, such as the embodiment illustrated in FIGS. 9-16, the arm 214 includes or is a flange 216 (seen most clearly in FIG. 9). The flange 216 may be formed by bending a portion(s) of the locking bar 212. Those of skill in the art will recognize that, when the flange 216 engages a flanged surface of the storage box 300, the storage box 300 will be held firmly against the rigid plate 202, and thus unable to move until the mounting plate 100, 200 is unlocked.

In some embodiments, the rigid plate 102, 202, the locking bar, 112, 212, and/or the arm 114, 214 may substantially made of a metallic material, such as a steel, to allow for rugged use in, for example, a truck bed or outdoor work vehicle.

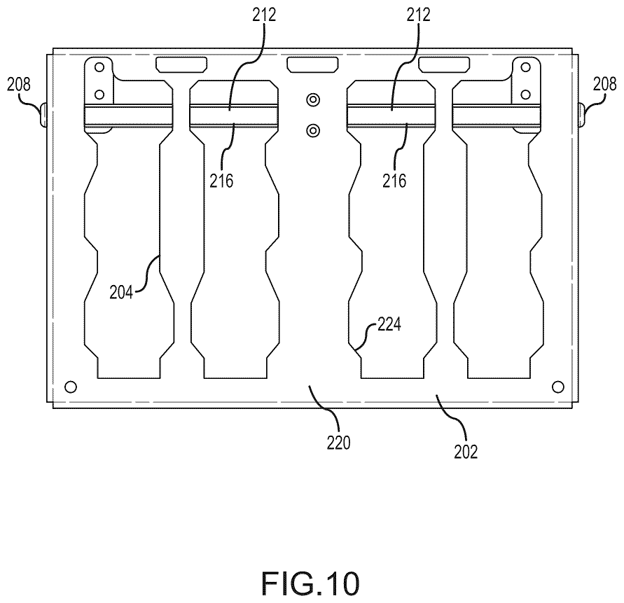

As seen most clearly in FIG. 10, the mounting plate 200 may have two locks 208 operable independently of one another. The locks 208 may be configured to engage two different storage boxes 300 in a manner that should be apparent to those of skill in the art.

Those of skill in the art will also recognize that, although two embodiments of the mounting plate 100, 200 are illustrated, numerous shapes can be utilized. In particular, the outer boundaries of the mounting plate 100, 200 can be any suitable shape, and the mounting means 106, 206 can be any suitable shape. That is, a design claim may be made to include only a subset of features shown in the illustrations, such as a design claim to a face of the rigid plate 102, 202 having the recesses 104, 204 and/or any one or more of the lock 108, 208, the locking bar 112, 212, and arm 114, 214.

Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, the disclosure of a “attachment mechanism” should be understood to encompass disclosure of the act of “attaching”—whether explicitly discussed or not—and, conversely, were there only disclosure of the act of “attaching”, such a disclosure should be understood to encompass disclosure of a “attaching mechanism”. Such changes and alternative terms are to be understood to be explicitly included in the description.

Moreover, the claims shall be construed such that a claim that recites “at least one of A, B, or C” shall read on a device that requires “A” only. The claim shall also read on a device that requires “B” only. The claim shall also read on a device that requires “C” only. The claim shall also read on a device that requires “A+B”. The claim shall also read on a device that requires “A+B+C”, and so forth.

Those skilled in the art can readily recognize that numerous variations and substitutions may be made in the invention, its use and its configuration to achieve substantially the same results as achieved by the embodiments described herein.

Accordingly, there is no intention to limit the invention to the disclosed exemplary forms. Many variations, modifications and alternative constructions fall within the scope and spirit of the invention as expressed in the claims.

1. A mounting plate for a storage box, comprising:
a rigid plate having a front face having a surface, a back face opposite the front face, and at least one passage through the front face to the back face, the passage shaped and configured to receive a portion of a storage box; and
a lock for temporarily locking the storage box to the rigid plate;
wherein the lock comprises
(a)a key mechanism accessible from a user side, the user side positioned on a side not being the second side; and
(b)a rotatable locking bar positioned on the second side, the rotatable locking bar having a flange, the rotatable locking bar further responsive to an activation of the key mechanism, whereby the flange is configured to engage the storage box when the lock is in a locked configuration;
and wherein the passage and the rotatable locking bar are shaped and configured to affix the storage box substantially adjacent the front face of the rigid plate when the lock is in the locked configuration.

2. The mounting plate of claim 1, wherein:
the locking bar and flange are substantially made of a metallic material.

3. The mounting plate of claim 1, wherein:
the rigid plate is substantially made of a metallic material.

4. The mounting plate of claim 1, wherein:
the passage is shaped and configured to receive a protrusion on the storage box.

5. The mounting plate of claim 1, wherein:
the passage comprises a ledge shaped and configured to support a lower portion of the storage box.

6. The mounting plate of claim 1, comprising:
a plurality of passages for receiving a plurality of protrusions on the storage box.

7. The mounting plate of claim 1, comprising
two locks operable independently of one another.

8. The mounting plate of claim 1, wherein:
the flange of the lock is configured to engage a flange surface in the storage box when the lock is in the locked configuration.
